(19) United States
(12) Patent Application Publication
(10) Pub. No.: US 2010/0272851 A1
(43) Pub. Date: Oct. 28, 2010

(54) INJECTION MOLDING NOZZLE

(76) Inventors: Herbert Günther, Allendorf (DE); Siegrid Sommer, Burgwald (DE); Torsten Schnell, Lichtenfels (DE)

Correspondence Address: CLARK & BRODY, 1700 Diagonal Road, Suite 510, Alexandria, VA, 22314, US

(21) Appl. No.: 12/746,235

(22) PCT Filed: Oct. 29, 2008
(86) PCT No.: PCT/EP08/09105

§ 371 Date: Jun. 4, 2010

(30) Foreign Application Priority Data
Dec. 5, 2007 (DE) 20 2007 017 083.1

(51) Int. Cl. B29C 45/27

(52) U.S. Cl. 425/570

(57) ABSTRACT

The present invention relates to an injection molding nozzle (10) for injection molding equipment, comprising at least two processing-material feed pipes (20) each subtending a flow duct (30) passing a fluid processing material. Each pipe (20) supports circumferentially a heater (40) and comprises a terminal nozzle tip (32) which is fitted with at least one discharge aperture (34) for said fluid material. Several nozzle tips (32) pass through separate, tightly adjacent recesses (60) receiving the processing-material feed pipes (20) that are received in a common housing (50) and exhibit uniform heat transfer and temperature distribution characteristics, making possible even minute cavity spacings.

The present invention relates to an injection molding nozzle as defined in the preamble of claim 1.

Injection molding nozzles are used in injection molding equipment to feed a flowable/fluid processing material at a predeterminable temperature and under high pressure to a separable molding block (mold cavity). Typically such nozzles comprise a nozzle casing in the form of a processing-material feed pipe subtending within it a flow duct for said material. The flow duct terminates in a nozzle orifice element terminally inserted in the said feed pipe and constituting said flow duct's discharge aperture. Typically the feed pipe is received within a housing connected in such a way to a manifold plate in the injection mold that the processing-material feed pipe's flow duct communicates with the flow conduits in said manifold plate to implement the flow of processing material.

An electric heater concentrically encloses the processing-material feed pipe respectively the flow duct subtended within it in order to preclude premature cooling of the mostly hot processing material within the nozzle. This feature allows keeping said fluid processing material at a constant temperature as far as into the nozzle tip. Thermal insulation between the hot housing and the substantially cooled mold assures that—in particular in the area of the nozzle tip—the nozzle be protected against freezing effects and that simultaneously the mold (cavity) shall not be heated. The temperature is typically monitored using a temperature sensor.

The processing-material feed pipe and the heater may be designed as separate components, in which shell the heater is integrated, together with the temperature sensor, in one shell peripherally slipped onto the nozzle casing. However the heater also may be integrated into the processing-material feed pipe, for instance in the form of a tubular heater or a coiled heater, or being a heating layer bonded to said pipe.

The above conventional nozzles incur a substantial drawback in that the injection molding nozzle's housing is relatively bulky, as a result of which the nozzle tips of the individual nozzles cannot be arrayed arbitrarily closely next to each other. The cavity spacings also are relatively large. But many applications require minimal inter-cavity spacings to allow injecting several or complex cavities arrayed very near to each other.

Conventional nozzles also incur another drawback in that the housing consists of several parts so that assembly is commensurately made more expensive. Frequently the processing-material feed pipe is installed in the housing only when the mold is being assembled, this feature also raising the cost of assembly. Assembly defects may arise that will interfere with the subsequent production.

Accordingly it is the objective of the present invention to overcome the above and other drawbacks of the state of the art and to create an injection molding nozzle configuring several nozzle tips most compactly, thereby allowing even minimal cavity interspacings. The nozzle of the present invention moreover shall be characterized by uniform heat transfer and temperature distribution also when installed into injection molding equipment and exhibiting said compactness. Moreover it is produced economically and cheap to assemble.

Claim 1 specifies the main features of the present invention. Claims 2 through 24 relate to embodiment modes.

As regard's an injection mold's nozzle comprising at least two processing-material feed pipes, each pipe being fitted with a flow duct passing a fluid processing material and comprising at its end a nozzle tip having at least one discharge aperture for said material, further each pipe being fitted circumferentially with a heater, the present invention provides that said processing-material feed pipes be configured in a common housing that is designed with a separate recess for each of said pipes, said recesses being configured tightly adjacent to each other in said housing.

This feature allows fitting only one injection molding nozzle with several nozzle tips in most compact manner because in such a design the processing-material feed pipes are configured tightly against and parallel to one another within said housing. Accordingly the said injection molding nozzle constitutes a multiple nozzle allowing injecting simultaneously several mold cavities or gates. The intercavity spacings respectively the gate spacings therefore may be selected being exceedingly small.

In the present invention, each processing-material feed pipe is fitted with its own separate recess. Accordingly each housing recess is associated with a separated processing-material feed pipe having its separate flow duct, making it feasible to optionally using only one nozzle for various processing materials being fed to gating sites very close to each other.

The present invention offers the further advantage of using a different design for each processing material and for each heater in relation to the particular processing material. Illustratively the processing-material feed pipes may be made of different substances while the heaters are sized and/or operated in different manners.

Small intercavity spacings also may be more easily attained when the spacing between the inside walls of two adjacent recesses is less than their minimum radius. In that manner the processing-material feed pipes are configured most compactly within the housing which in turn may be made more compact.

Preferably the said spacings are the same size. However they may also differ from one another depending on the items to be produced.

Particular advantages are attainable by fitting the said recesses in the manner of a matrix into the said housing. A matrix herein connotes a pattern of spots arrayed in rows and columns. Such a spot configuration also is feasible for the processing-material feed pipes and hence for the nozzle tips which then may be individually matched to given product requirements. Thus a product may be simultaneously injected with several of its components, for instance being a keypad having several keys made of different substances. The nozzle tips may be made very narrow, and accordingly the individual keys may be arrayed very tightly against each other.

In a further embodiment mode of the invention, each recess is stepped, namely comprising a first lower segment and a second upper segment, the first lower segment's diameter being larger than the inside diameter of the second upper segment. Due to this design, each recess receives in problem-free manner the processing-material feed pipe associated with it, the upper segment being available to affix said pipe.

In the further design, said pipe preferably comprises a first lower potion and a second upper portion, the heater being preferably situated in the region of the said feed pipe's first portion.

Preferably the processing-material feed pipe is affixed in the recess' upper segment in the housing, namely by the processing material feed pipe's second portion being affixed in the associated recess' second segment. Advantageously the processing-material feed pipe is press-fitted by its second portion into its associated recess' second segment. This feature minimizes assembly costs. Additional fastening elements are not needed.

In addition or alternatively, the processing-material feed pipe also may soldered, welded or bonded into the housing. Screw connection also may be used, for instance by appropriately threading the upper segment and portion respectively of the recess and the said pipe.

In order to always keep the melt passing through the processing-material feed pipe optimally and uniformly heated, the heater of each processing-material feed pipe extends as far as into the first segment of the recess associated with said pipe, the heater's outside diameter in the injection molding nozzle's cold state being less than the diameter of the first recess segment. In this manner the nozzle may be installed rapidly and simply. Initially there is adequate room for the heater in the recess.

On the other hand, when the injection molding nozzle is in operation, the heater's outside diameter equals the inside diameter of the recess' first segment. Thereby the heater makes thermal contact with the housing, hence the first upper portion of said pipe also is kept optimally heated. In this manner the entire injection molding nozzle is kept at a uniform and homogeneous temperature distribution as far as into the nozzle tip. This design of the present invention offers high compactness and economy.

In order to maintain the required temperature constant not only across the full nozzle length but also within each individual processing-material feed pipe, the present invention also calls for each heater being driven by its own control.

In a further embodiment mode of the invention, the housing is fitted with an insulating plate. It insulates thermally the hot housing against the substantially cold mold cavity plate, thereby minimizing temperature drops and simultaneously preventing the nozzle tips from freezing.

Preferably the thermally insulating plate is affixed to the housing. Said plate also is fitted with boreholes congruent with said recesses, as a result of which the processing-material feed pipes can be inserted from below into eh housing recesses.

In order to accurately and reproducibly align the housing inside the mold, this housing is fitted with a minimum of one dowel preferably passing through the thermally insulating plate whereby this plate shall always be optimally positioned relative to the housing as well as the mold.

In still another embodiment mode of the invention, the processing-material feed pipe is enclosed by a shell. This shell improves further the thermal insulation in the mold. Also the heater is shielded from external effects. This shell is appropriately made in several parts, for instance an upper and a lower part, this lower part making contact with the processing-material feed pipe optionally being made of a substance of low thermal conductivity.

Each shell projects into an associated borehole in the thermally insulating plate. This feature allows simple shell affixation. At the same time the thermal insulation is improved.

Further features, particulars and advantages of the invention are defined in the appended claims and in the discussion below of illustrative embodiments of the invention in relation to the drawings.

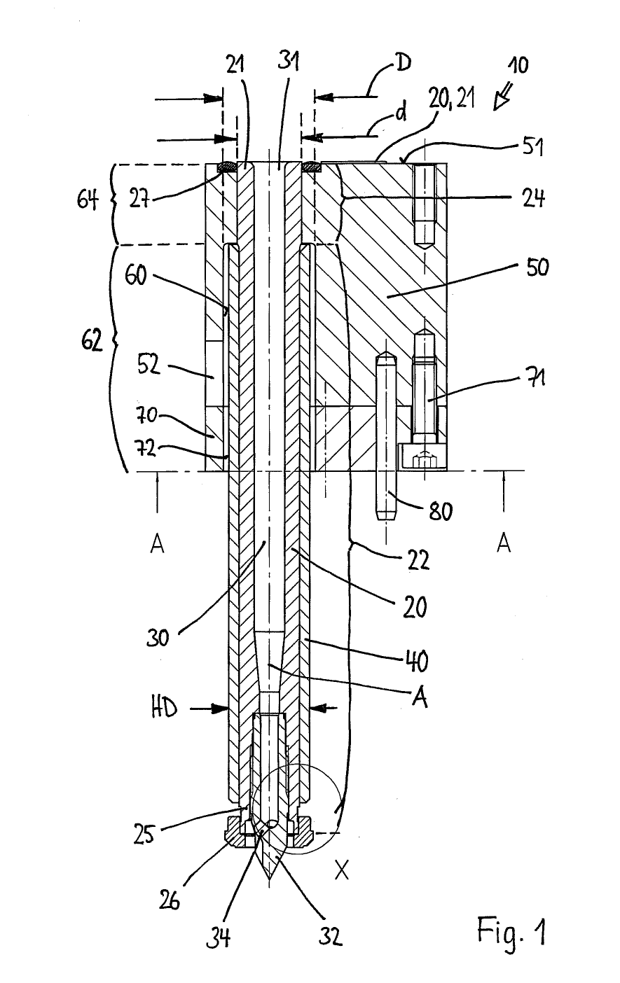

FIG. 1 shows a longitudinal section of a first embodiment mode of the injection molding nozzle,

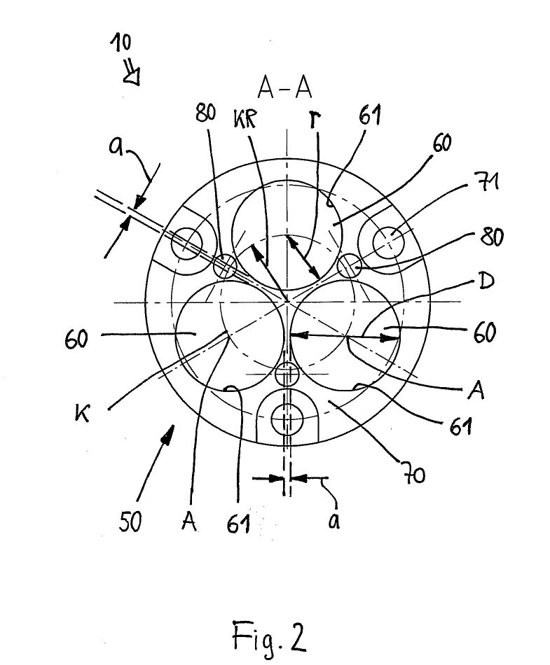

FIG. 2 is a view in the direction A-A of FIG. 1,

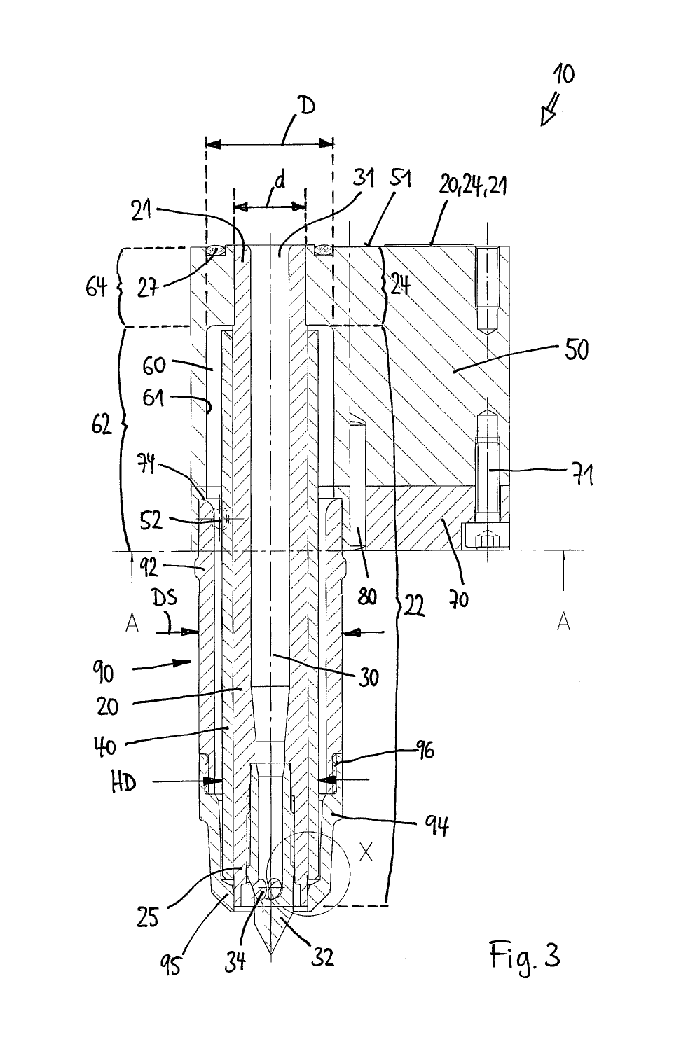

FIG. 3 is a longitudinal section of another embodiment mode of an injection molding nozzle,

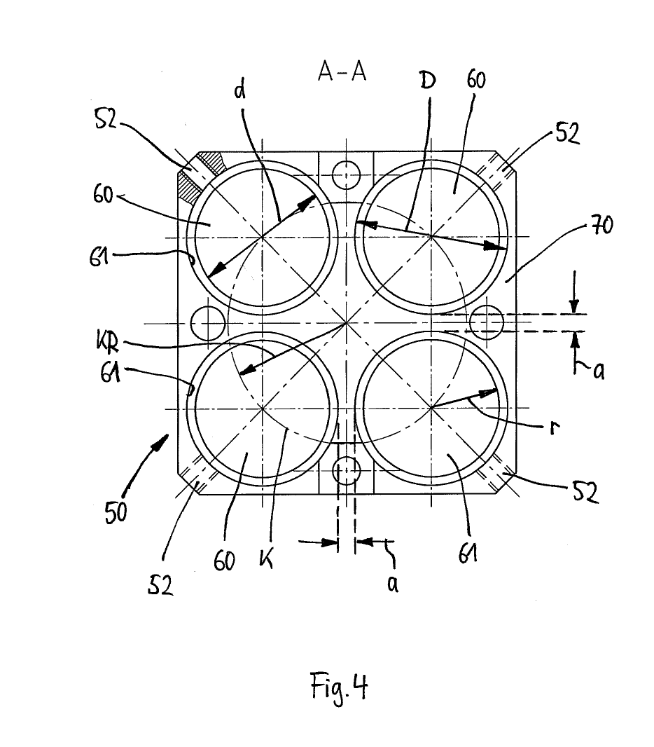

FIG. 4 is a view in the direction A-A of FIG. 3,

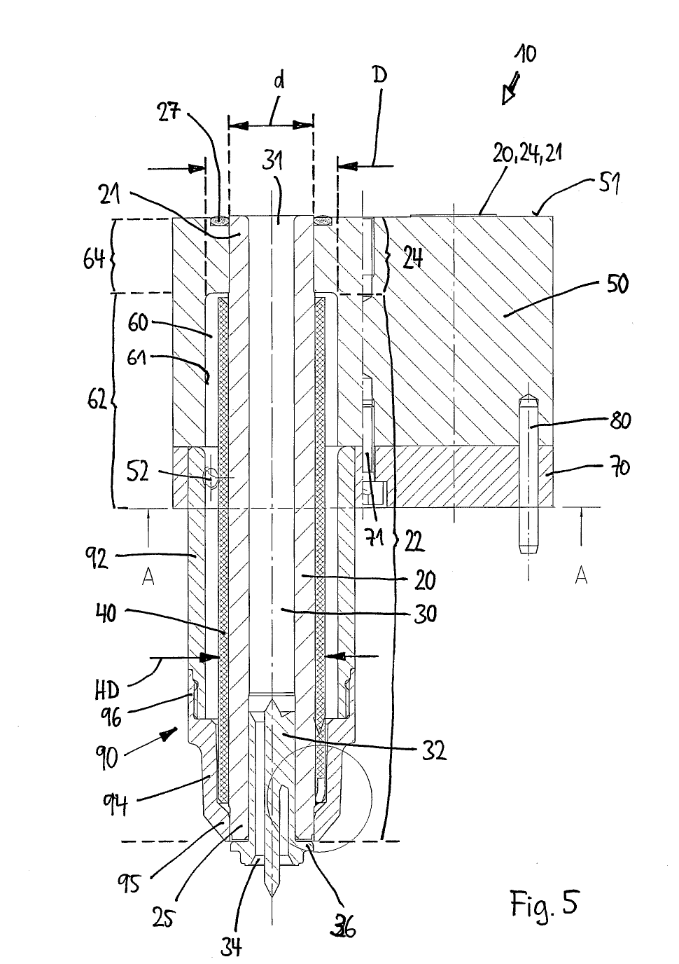

FIG. 5 is a longitudinal section of another embodiment mode of an injection molding nozzle, and

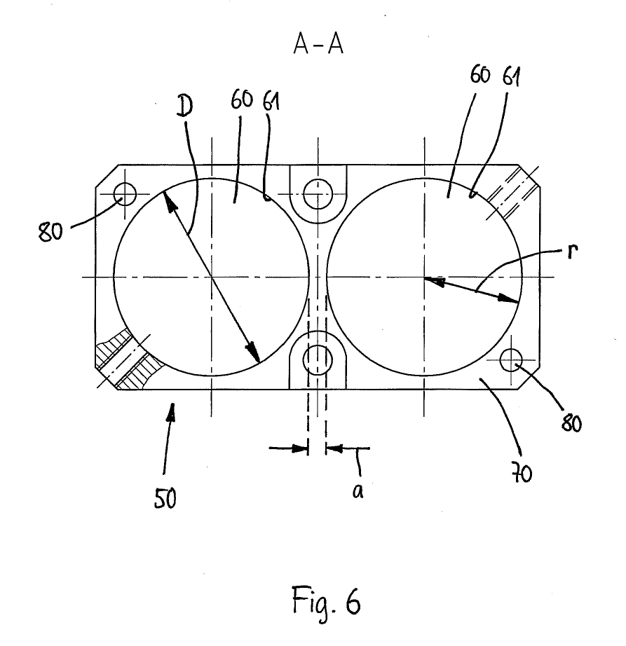

FIG. 6 is a view in the direction A-A of FIG. 5.

The injection molding nozzle 10 shown in FIG. 1 is a hot runner nozzle. It is used to process a fluid/flowable material, for instance a plastic melt, in an omitted mold. In the process, said melt is fed at a predeterminable temperature and under high pressure through an omitted manifold plate and through the injection molding nozzle 10 to a separable mold block (mold cavity) and shall be shaped according to the design of the individual mold cavity inserts into plastic items. The injection molding nozzle 10 is fitted for that purpose with a total of three processing-material feed pipes 20 tightly configured next to one another in a common housing 50, each center axis A being situated within the housing 50 on a circle K (FIG. 2).

Each processing-material feed pipe 20 is fitted with a flow duct 30 centered on the center axis A and passing said fluid processing material, said duct beginning with an intake aperture 31 and issuing at its lower end 25 into a nozzle tip 32. This nozzle tip 32 guides the plastic melt through a processing material discharge aperture 34 into one of the omitted mold cavities, the preferably conical peak of the nozzle tip 32 being situated in a separation plane in front of an omitted gate aperture. The nozzle tip 32 preferably is made of a thermally highly conducting substance and is inserted terminally, preferably screwed, into the said feed pipe 20. However, depending on application, said nozzle tip may be integral with the pipe 20 while retaining the same functionality.

A centering ring 26 made of a substance of low thermal conductivity is mounted on the lower end 25 of the processing-material feed pipe 20 in order to accurately center the nozzle tip 32 relative to the gate aperture. This ring 26 enters the omitted mold cavity plate fitted with an appropriate receiving seat of the injection molding equipment. The centering ring 26 seals said pipe 20 relative to the mold cavity plate, as a result of which the processing material issuing the discharge aperture 34 directly enters the mold cavity. The thermally poorly conducting substance of the ring 26 assures the required thermal insulation.

In the housing 50, a sealing ring 27 is configured concentrically with the processing-material feed pipe 20 to seal the injection molding nozzle 10 relative to the manifold plate. In the assembled state of the injection molding nozzle 10, said sealing ring 27 rests in sealing manner within an unreferenced housing groove against the said pipe 20 and against the manifold plate's lower side. At the same time the processing-material feed pipe 20 projects modestly (preferably a few tenths or hundredths mm) by its plane top end 21 beyond the plane top side 51 of the housing 50, as a result of which, when the injection molding nozzle 10 has been heated, its thermal expansion shall firmly press said pipe 20 against the manifold plate while the centering ring 26 is firmly pressed at its lower end into the mold cavity plate. The entire system is always reliably sealed.

An electric heater 40 is deposited on the outer circumference of the processing-material feed pipe 20. Illustratively said heater consists of an unreferenced sleeve made of a substance of high thermal conductivity, for instance copper or brass, and it runs over a large portion of the axial length of said pipe 20. An omitted electrical heating coil is configured coaxially with the flow duct 30 in the omitted wall of said sleeve, said coil's omitted hookups running sideways out of the housing 50. This housing 50 is appropriately fitted with an aperture 52 passing said hookups. The heater 40 is connected to an omitted control, central or a separate controlling action being optional for each of the three heaters 40 of the nozzle 10. The outside diameter HD of the heater 40 essentially determines the outside diameter of the processing-material feed pipe 20.

An omitted receiving conduit to receive an omitted temperature sensor is configured in the immediate vicinity of the pipe 20 to detect the temperature generated by the heater 40. Said temperature sensor's detecting end is situated in vicinity of the nozzle tip 32. The omitted hookups of the temperature sensor run sideways from the heater 40 and also are connected through the aperture 52 in the housing 50 to the control for the heater 40. Each heater 40 is fitted with its own temperature sensor.

FIG. 1 shows the processing-material feed pipe 20 subtending two portions 22, 24. A first lower portion 22 supports the heater 40 while a second upper portion 24 is diametrically somewhat wider than the first lower portion 22. Essentially the length of the heater 40 corresponds to the length of the first lower portion 22 of the pipe 20 which is much larger than the length of the second upper portion 24 of the pipe 20.

For each processing-material feed pipe 20, the housing 50 is fitted with a recess 60 of which the center axes A also are situated on the circle K. The recesses 60 are rayed tightly adjacent to each other within the housing 50, the separation between the inside walls 61 of two adjacent recesses 60 being significantly smaller than their minimum radius r (FIG. 2). As a result, the processing-material feed pipes 20 inserted into the recesses 60 are configured relatively very tightly against each other, thereby making possible minute inside dimensions. In the embodiment mode of FIG. 1, all spacings “a” are equal. However, depending on the configurations of the mold cavities or the gate sites, the spacings “a” may be selected being different from each other.

Each recess 60 is stepped, i.e. having a first lower segment 62 and a second upper segment 64. The inside diameter D of the first lower segment 62 is larger than that of the second upper segment 64, of which the length is less than that of the lower segment 62.

As shown in FIG. 1, each processing-material feed pipe 20 is inserted in an associated recess 60 and is affixed to, preferably press-fitted by its second portion 24 into, the second segment 64 of its associated recess 60. The outside diameter of the second portion 24 of the processing-material feed pipe 20 accordingly is slightly larger than the diameter d of the second segment 64 of the recess 60, whereby a permanent press-fit is attained.

As further shown by FIG. 1, the heater 40 deposited on the lower portion 22 of the pipe 20 runs as far as and into the first segment 62 of the recess 60 associated with the said pipe 20, the inside diameter D of the lower segment 64 and the outside diameter HD of the heater 40 being selected in a way that, in the cold state of the injection molding nozzle 10, the said diameter HD is less than the inside diameter D of the lower segment 64 of the recess 60. In the operational state of said nozzle 10, however, the outside diameter HD of the heater is equal to the inside diameter D of the first segment 62 of the recess 60, as a result of which the housing 50 also shall be heated by said heater. Accordingly the portion 22 of the processing-material feed pipe 20 situated in the upper segment 62 of the recess 60 is also being heated with an advantageous total temperature distribution within the nozzle 10.

It matters in the present invention that each processing-material feed pipe 20 be associated with its own separate recess 60. As a result, on one hand the spacing “a” between the recesses 60 has become significantly smaller than the minimum radius r of the recess 60. At the same time the radius KR of the circle K is only slightly larger than, or equal to the outside radius of HD of the heater 40, in other words, the radius KR of the circle K is only slightly larger, or equal to the unreferenced radius of said pipe 20 together with the heater 40. Again in still other words, the diameter of the circle K is slightly larger than or equal to the outside diameter HD of the heater 40. As a result, all the processing-material feed pipes 20 are configured most tightly against one another within the housing. The gauge of the nozzle tips 32 is minute, and accordingly exceedingly small cavity spacings may be attained within the mold.

The processing-material feed pipes 20 may be operated uniformly, that is the same said material passes through each of said three pipes. Alternatively the pipes 20 may be operated independently of one another, that is, optionally or as needed, a different plastic may be fed through each pipe 20, each heater 40 of such a pipe 20 being individually driven by the control (while preserving still the extremely densely distributed adjacent injection spots.

An insulating plate 70 affixed by screws 71 to the housing 50 thermally insulates this housing from the cooled mold plates. This insulating plate 70 is fitted with continuous boreholes 72 which are congruent with the recesses 60 in the housing 50, the inside diameters of said boreholes 72 being the same as the inside diameter D of the first segment 62 of the recesses 60, allowing passing the processing-material feed pipes 20 together with their heaters 40 through said insulating plate 70.

Three dowels 80 each enter by one end the housing 50 and by the other end the mold through the thermally insulating plate 70 and are used to align in defined manner the housing 50 within the mold.

The design of the injection molding nozzle 10 shown in FIGS. 3 and 4 substantially corresponds to the design of the nozzle shown in FIGS. 1 and 2, except that in FIGS. 3 and 4 four processing-material feed pipes 20 are employed and that each pipe 20 and each heater 40 are enclosed by a shell 90.

The shell 90 is made of several parts, preferably two parts, an upper shell part 92 and a lower shell part 94. The upper shell part 92 is inserted by its upper edge into the thermally insulating ring 70 which for that purpose is fitted with a step 74 in the region of its continuous borehole 72. The shell part 94 may be press-fitted into the insulating ring 70. However both shell parts also may be screwed into each other. The lower shell part 94 rests by its lower end 95 against the processing-material feed pipe 20. Said part 94 is made of a substance of low thermal conductivity to avert heat being dissipated by means of said pipe 20. To allow the pipe 20 to move during the heating and cooling phases in the shaft part 94 snugly resting against it, the lower end 95 of the shell part 94 constitutes a displaceable seat for the processing-material feed pipe 20, preferably in the form of a cylindrical inside surface resting in geometrically enclosing manner on the outer surface of said pipe 20. The upper and lower shell parts 92 and 94 respectively are preferably screwed or soldered to each other at their separation site 96.

Significantly, each processing-material feed pipe 20 is associated with its own separate recess 60, the spacing “a” between the recesses 60 being significantly smaller than the minimum radius r of the recess 60. At the same time the radius KR of the circle K is only slightly larger than, or equals half the outside diameter HS of the shell 90, that is, the radius KR of the circle K is only slightly larger, or equals the unreferenced radius of the shell 90. In other words still: the diameter of the circle K is slightly larger than, or equals the outside diameter HS of the shell 90. In this embodiment mode therefore all feed pipes 20 therefore also are configured most compactly tightly against each other in the housing 50. The gauge of the nozzle tips 32 is minute, and therefore minute cavity spacings can be implemented in the mold.

Two processing-material feed pipes 20 are configured next to each other in the housing 50 of the embodiment mode of FIGS. 5 and 6. The nozzle tip 32 is fitted terminally with a flanged ring 36 supported between the said pipe 20 and the mold, an omitted insert made of a substance of low thermal conductivity being configured between said flanged ring 36 and the mold to minimize the heat transfer from the nozzle tip 32 to the mold.

The present invention is not restricted to the above discussed embodiment modes but may be modified in many ways. Illustratively the heater 40 need not necessarily be deposited on the processing-material feed pipe 20. Instead the heater 40 also may be bonded onto the said pipe, for instance in the form of layer, in particular being a thick-film heater.

The processing-material feed pipe 20 also may be soldered/welded by its upper portion 24 into/onto the housing 50. It also may be bonded to it.

Once the operational temperature has been reached, the housing 50 and the thermally insulating plate 70 may be preferably clamped between the manifold plate and the mold plates, the dowels 80 always assuring the proper alignment of the housing 50 and the pipes 20. In addition or alternatively, the housing 50 may also be screwed onto the manifold plate.

The processing material feed pipes 20 and hence the nozzle tips 32 are arrayed in a grid to be tightly adjoining each other. Depending on the array of the gate sites, their configuration also may subtend a matrix.

All features and advantages, including design details, spatial configurations and procedural steps, explicit from or implicit in the above claims, discussions and appended drawings, may be construed being inventive per se or in arbitrary combinations.

### LIST OF REFERENCES

a spacing/distance
A center axis/longitudinal axis
D,d inside diameter
r radius
HD outside diameter
K circle
KR radius
10 hot runner nozzle
20 processing material feed pipe
21 upper end
22 first portion
24 second portion
25 lower end
26 centering ring
27 sealing ring
30 flow duct
31 intake aperture
32 nozzle tip
34 discharge aperture
36 flanged ring
40 heater
50 housing
51 top side
52 aperture
60 recess
61 inside wall
62 first segment
64 second segment
70 [thermally] insulating plate
71 screw
80 dowel
90 shell
92 upper shell part
94 lower shell part
95 lower end
96 separation site

1. An injection molding nozzle (10) for injection molding equipment, comprising at least two processing-material feed pipes (20) each one of which subtends a flow duct (30) for a flowable/fluid processing material, each pipe (20) being terminally fitted with a nozzle tip (32) comprising at least one discharge aperture (34) for the fluid processing material, and each processing-material feed pipe (20) supporting on its outer circumference a heater (40),
characterized in that
(A) the processing-material feed pipes (20) are configured within a common housing (50),
(B) the housing (50) is fitted with a separate recess (60) for each of said pipes (20), and
(C) the recesses (60) are spaced compactly next to each other in the housing (50).

2. Injection molding nozzle as claimed in claim characterized in that a separate recess (40) is provided for each processing-material feed pipe (20).

3. Injection molding nozzle as claimed in claim 1, characterized in that the spacing (a) between the inside walls (61) of two adjacent recesses is smaller than said recesses' minimum radius (r).

4. Injection molding nozzle as claimed in claim 1, characterized in that the spacings (a) are equal in size.

5. Injection molding nozzle as claimed in claim 1, characterized in that the spacings (a) are different.

6. Injection molding nozzle as claimed in claim 1, characterized in that the recesses (60) are fitted into the housing (50) in the manner of a matrix.

7. Injection molding nozzle as claimed in claim 1, characterized in that each recess (60) is stepped, namely configured as a first lower segment (62) and a second upper segment (64).

8. Injection molding nozzle as claimed in claim 7, characterized in that the inside diameter (D) of the first segment (62) is larger than the inside diameter (d) of the second segment (64).

9. Injection molding nozzle as claimed in claim 1, characterized in that each processing-material feed pipe (20) comprises a first lower portion (22) and a second upper portion (24).

10. Injection molding nozzle as claimed in claim 9, characterized in that the heater (40) is configured in the region of the first portion (22) of the processing-material feed pipe (20).

11. Injection molding nozzle as claimed in claim 9, characterized in that the processing-material feed pipe (20) is affixed by its second portion (24) in the second segment (64) of its associated recess (60).

12. Injection molding nozzle as claimed in claim 11, characterized in that the processing-material feed pipe (20) is press-fitted by its second portion (24) into the second segment (64) of its associated recess (60).

13. Injection molding nozzle as claimed in claim 7, characterized in that the heater (40) of each processing-material feed pipe (20) extends as far as into the first segment (62) of the recess (60) associated with said pipe.

14. Injection molding nozzle as claimed in claim 7, characterized in that, in the cold state of the injection molding nozzle (10), the outside diameter (HD) of the heater (40) is less than the diameter (D) of the first segment (62) of the recess (60).

15. Injection molding nozzle as claimed in claim 7, characterized in that, in the operational state of the injection molding nozzle (10), the outside diameter (HD) of the heater (40) is equal to the inside diameter (D) of the first segment (62) of the recess (60).

16. Injection molding nozzle as claimed in claim 1, characterized in that each heater (40) of a processing-material feed pipe (20) may be driven individually by a control.

17. Injection molding nozzle as claimed in claim 1, characterized in that the housing (50) is fitted with a thermally insulating plate (70).

18. Injection molding nozzle as claimed in claim 17, characterized in that the thermally insulating plate (70) is affixed to the housing (50).

19. Injection molding nozzle as claimed in claim 17, characterized in that the thermally insulating plate (70) is fitted with continuous boreholes (72) which are congruent with the recesses (60).

20. Injection molding nozzle as claimed in claim 1, characterized in that the housing (50) comprises at least one dowel (80).

21. Injection molding nozzle as claimed in claim 20, characterized in that the dowel (80) passes through the thermally insulating plate (70).

22. Injection molding nozzle as claimed in claim 1, characterized in that the processing-material feed pipe (20) is enclosed by a shell (90).

23. Injection molding nozzle as claimed in claim 22, characterized in that the shell (90) consists of several parts.

24. Injection molding nozzle as claimed in claim 22, characterized in that each shell enters an associated continuous borehole (72) of the thermally insulating plate (70).
